(19) United States
(12) Patent Application Publication
(10) Pub. No.: US 2008/0099653 A1
(43) Pub. Date: May 1, 2008

(54) ANCHOR RACK HAVING A COUPLING PAWL

(76) Inventors: Wei-Jen Chiang, Taipei (TW); Kun-Yen Lu, Taipei (TW)

Correspondence Address: Wei-Jen Chiang, No; 147, Sec 3, Beishen Rd, Shenkeng Shiang, Taipei, omitted

(21) Appl. No.: 11/554,860

(22) Filed: Oct. 31, 2006

(51) Int. Cl. E04G 25/00; F16B 47/00; H02M 5/27

(52) U.S. Cl. 248/500; 248/351; 248/205.5; 363/1

(57) ABSTRACT

An anchor rack having a coupling pawl has a plurality of slots on the coupling pawl and a conical outer surface. A sleeve and an elastic element are provided to be coupled with the coupling pawl to form interactions with one another. The coupling pawl has an opening which can be extended or shrunk. Hence a housing space formed in the coupling pawl also can be extended or shrunk. Thereby a tight coupling with a holding rack can be easily formed.

### BACKGROUND OF THE INVENTION

1. Field of the Invention

The present invention relates to an anchor rack having a coupling pawl and particularly to an anchor rack that has a sleeve, a coupling pawl and a compressible spring that interact with one another to form a tight coupling with a holding rack.

2. Description of the Prior Art

Nowadays a wide variety of communication devices such as handsets (mobile phones), PDAs, GPS and the like are available to make communication among people more convenient. Users can talk to each other almost anywhere anytime.

Anchor racks for holding portable electronic devices are available in prior art. They mostly have a spherical joint on the bottom end of a holding rack and a bracket. The holding rack can be adjusted at various positions through the spherical joint. A fastening mechanism is provided to adjust the tightness of the spherical joint so that bars can be swiveled or fastened relative to one another at various positions to facilitate user's operation. However, use the communication devices concurrently with other tools while users are driving or riding on a transportation vehicle often incurs troubles. Although the conventional communication device anchor racks can hold various communication devices on the transportation vehicles, the holding racks are mostly fixed and cannot be adjusted to various directions, elevations and angles to suit user's requirements. Operation is difficult. They do not conform to ergonomics and user's habits. The benefits of the communication devices also are not fully exploited.

### SUMMARY OF THE INVENTION

In view of the aforesaid problems occurred to the conventional anchor racks, the present invention aims to provide an anchor rack equipped with a coupling pawl that has a sleeve and a coupling pawl of a selected profile interacting with each other to shrink an opening of the coupling pawl so that they can be coupled tightly and easily with a holding rack.

The anchor rack according to the invention is used on an electronic product. It includes a bracket, a coupling pawl which has a housing space with an opening on one end, a plurality of slots formed on the periphery around the opening, a conical outer surface and another end fastened to the bracket, a hollow sleeve which holds the coupling pawl and is movable on the conical outer surface of the coupling pawl in a restricted fashion, an elastic element located between the sleeve and the coupling pawl, and between the bracket and the sleeve, and a holding rack which has one end to hold the electronic product and a coupling portion on another end that has a distal end mating the surface of the housing space. The coupling pawl, sleeve and elastic element interact with one another to be anchored on the holding rack.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of an embodiment of the invention;

FIG. 2 is a sectional view of an embodiment of the invention in an initial condition;

FIG. 3 is a sectional view of an embodiment of the invention during an operating condition; and

FIG. 4 is a sectional view of an embodiment of the invention in a finished condition.

### DESCRIPTION OF THE PREFERRED EMBODIMENT

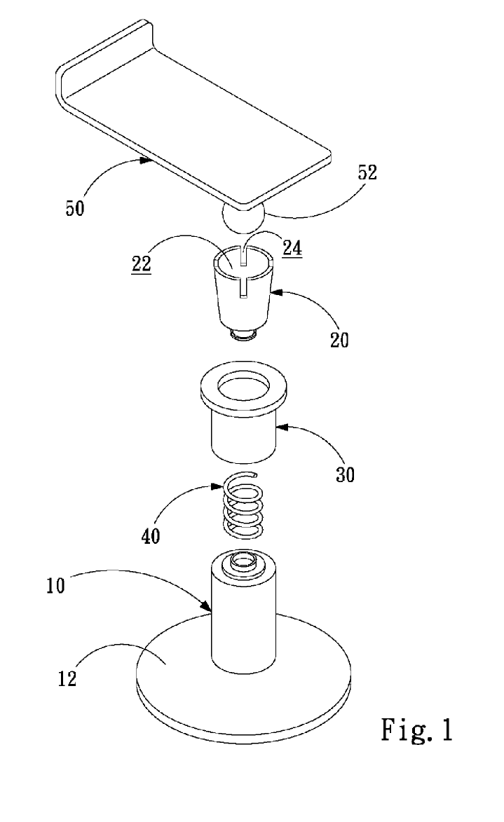

Refer to FIGS. 1 through 4 for an embodiment of the invention. The anchor rack having a coupling pawl of the invention mainly includes a bracket 10, a coupling pawl 20, a sleeve 30, an elastic element 40 and a holding rack 50.

The bracket 10 is a strut which has a suction tray 12 on a bottom end and a top end to hold the coupling pawl 20. The suction tray 12 can be adhered to the surface of various objects to brace the bracket 10, such as on the windshield of vehicles (not shown in the drawings). The coupling pawl 20 is a hollow and conical strut and has a housing space 22 with an opening formed on the top end and a conical outer surface, and another end to be fastened to another end of the bracket 10. The coupling pawl 20 further has a plurality of slots 24 formed axially downwards on the peripheral starting from the rim of the opening so that the coupling pawl 20 becomes a flexible structure around the housing space 22. The sleeve 30 is hollow to hold the coupling pawl 20. The coupling pawl 20 is fastened to the top end of the bracket 10 with the conical outer surface in contact with an opening of the sleeve 30 at the top end in normal conditions. The sleeve 30 is movable on the conical outer surface of the coupling pawl 20 in a restricted fashion. The elastic element 40 is interposed between the sleeve 30 and the coupling pawl 20, and has an action end fastened to the bracket 10 and another action end fastened to the sleeve 30 to provide a returning force for the sleeve 30 so that the sleeve 30 can be pushed and moved axially, and return to its initial position. The holding rack 50 has a holding portion on one end to hold an electronic product and a coupling portion 52 on another end mating the internal surface of the housing space 22 to be coupled therewith.

The coupling portion 52 of the holding rack 50 may be a spherical body mating the internal surface of the housing space 22 to be coupled therewith. With the coupling portion 52 formed in spherical, it can be swiveled in the housing space 22 about three axes that are normal to one another.

The elastic element 40 may be a coil spring held in the sleeve 30. It has an action end fastened to the top end of the bracket 10 and another action end fastened to an internal surface of the sleeve 30. Hence when the sleeve 30 is pushed downwards axially the elastic element 40 is compressed and generates an opposite elastic force. When the force of downward movement is released, the opposite elastic force of the elastic element 40 pushes the sleeve 30 axially to the initial position.

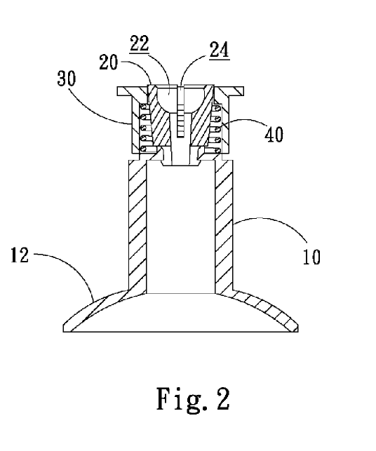

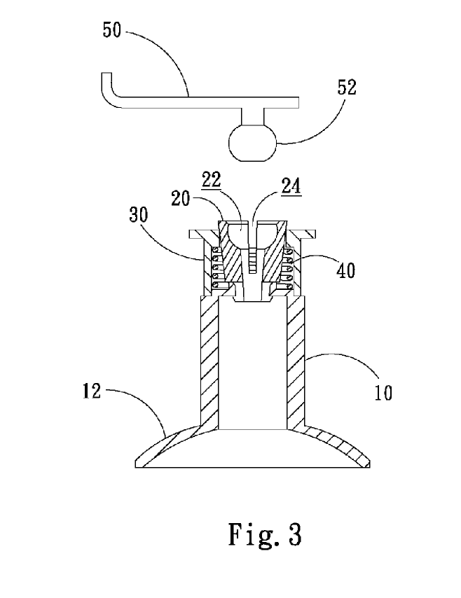

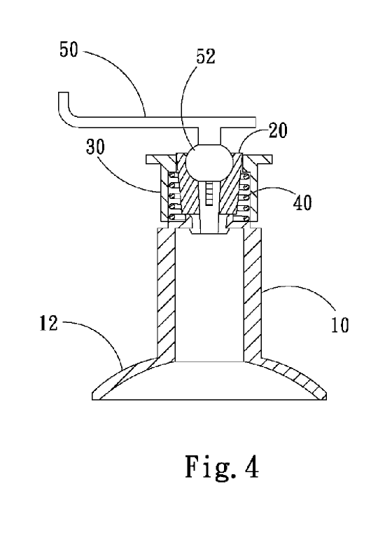

Referring to FIGS. 3 and 4, when in use, first, the sleeve 30 is subject to the upward returning force of the elastic element 40 so that there is a gap between the sleeve 30 and the bracket 10. As the opening on the upper end of the sleeve 30 is in contact with the conical outer surface of the coupling pawl 20, movement of the sleeve 30 is restricted. Because of the slots 24 on the coupling pawl 20, when the periphery of the coupling pawl 20 is pushed and squeezed (resulting from transformation of the returning force of the elastic element in this embodiment), the opening of the coupling pawl 20 shrinks, and the housing space 22 also shrinks (as shown in FIG. 2). Hence when the coupling portion 52 of the holding rack 50 is urged and inserted into the housing space 22, the sleeve 30 receives a force against the returning force of the elastic element 40 and is moved downwards. The opening of the coupling pawl 20 is extended outwards until reaching the initial condition or in contact with the sleeve 30 (referring to FIG. 3). Then the coupling portion 52 is inserted and held in the housing space 22. Finally, when the force exerting by users against the returning force of the elastic element 40 is released, the returning force of the elastic element 40 pushes the sleeve 30 upwards again so that the sleeve 30 shrinks the opening of the coupling pawl 20 again. Thus the coupling portion 52 can be anchored to facilitate operation control of the users.

In short, the anchor rack having a coupling pawl according to the invention employs interactions among the sleeve, coupling pawl and compressible spring to form a tight coupling with the holding rack. User operation is easier. It offers a significant improvement over the conventional techniques.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

What is claimed is:

1. An anchor rack having a coupling pawl to be used on electronic products, comprising:
a bracket;
a coupling pawl which is a hollow conical strut and has a housing space and a conical outer surface, the housing space having an opening on a top end to form a flexible structure;
a sleeve which is a hollow column and has an inner space extruding axially;
an elastic element which has an action end fastened to the bracket and another action end fastened to the sleeve; and
a holding rack which has a holding portion on one end and a coupling portion on another end, the coupling portion being matched with an internal surface of the housing space;
wherein the coupling pawl has a bottom end fastened to one end of the bracket and is held in the sleeve, the sleeve being movable on the conical outer surface of the coupling pawl in a restricted fashion.

2. The anchor rack of claim 1, wherein the coupling portion is a spherical body.

3. The anchor rack of claim 1, wherein the elastic element is a coil spring.

4. The anchor rack of claim 3, wherein the elastic element is located in the sleeve adjacent to an internal surface of the sleeve, the action end being fastened to a top end of the bracket and the another action end being fastened to the internal surface of the sleeve.

5. The anchor rack of claim 1, wherein the bracket has a suction tray.

6. The anchor rack of claim 1, wherein a inner surface defined as the housing space of the coupling pawl has a plurality of slots formed axially downwards on the periphery around the housing space starting form the rim of the opening such that the coupling pawl becomes a flexible structure around the housing space.
